(19) United States
(12) Patent Application Publication
(10) Pub. No.: US 2024/0104920 A1
(43) Pub. Date: Mar. 28, 2024

(54) IMAGE PROCESSING APPARATUS, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventors: SATOKO NAKAMAE, Kanagawa (JP); KOJI OKAWA, Tokyo (JP)

(21) Appl. No.: 18/466,888

(22) Filed: Sep. 14, 2023

(30) Foreign Application Priority Data
Sep. 22, 2022 (JP) 2022-151799

(51) Int. Cl. G06V 10/96; H04N 19/85

(52) U.S. Cl. CPC G06V 10/96; H04N 19/85

(57) ABSTRACT

An image processing apparatus includes a recognition unit configured to perform a recognition processing of an object on a frame, an encoding unit configured to perform an encoding process of a frame, and a generation unit configured to generate data including a result of the encoding process and a result of the recognition processing. The recognition unit performs the recognition processing only on a frame of a B picture when a processing cost of a most recent recognition processing is greater than or equal to a predefined amount.

### CROSS-REFERENCE TO PRIORITY APPLICATION

This application claims the benefit of Japanese Patent Application No. 2022-151799, filed Sep. 22, 2022, which is hereby incorporated by reference herein in its entirety.

### FIELD OF THE INVENTION

The present invention relates to an encoding technique.

### DESCRIPTION OF THE RELATED ART

In Annotated Regional SEI (ARSEI), which is an H.265 standard, information such as data indicating the type and position of an object within an angle of view can be attached to a stream as metadata.

The maximum number of objects handled in the ARSEI is set to 255 in the specification, where the upper left coordinate of the object is represented by a two-dimensional coordinate of 4 bytes, and the width and height of the object are each represented by 2 bytes. Therefore, the position information of the object (information representing the upper left coordinate of the object and the width and height of the object) is represented by a total of 8 bytes.

In order to attach ARSEI metadata to a stream, it is necessary to perform an object recognition processing on an image before encoding the image. Since it takes time to perform advanced recognition processing for identifying a type of each object or calculating position information, a delay occurs when a processing load increases, for example, when the number of objects increases.

Furthermore, in a group of pictures (GOP), there are B pictures that refer to past and future frames by bidirectional prediction. In a case in which the recognition processing is applied to a later frame, in time-series, referred to by the B picture, the B picture can be encoded after the recognition processing and the encoding process of the frame are completed, and hence the delay is further increased. For example, as disclosed in Japanese Patent Laid-Open No. 2000-78563, there is known a method of reducing a load of the recognition processing by generating an image having a low resolution and applying the recognition processing.

However, in ARSEI, a result of advanced recognition processing such as a type of an object and position information is added to a stream as metadata, and thus accuracy is not sufficient in the recognition processing for an image having a low resolution. Therefore, the prior art is not a solution to the increase in delay due to advanced recognition processing and encoding.

### SUMMARY OF THE INVENTION

The present invention provides a technique for suppressing an increase in delay in a case in which object recognition processing is performed on a frame to be encoded.

According to the first aspect of the present invention, there is provided an image processing apparatus comprising: a recognition unit configured to perform a recognition processing of an object on a frame; an encoding unit configured to perform an encoding process of a frame; and a generation unit configured to generate data including a result of the encoding process and a result of the recognition processing; wherein the recognition unit performs the recognition processing only on a frame of a B picture when a processing cost of a most recent recognition processing is greater than or equal to a predefined amount.

According to the second aspect of the present invention, there is provided an image processing method performed by an image processing apparatus, the method comprising: performing a recognition processing of an object on a frame; performing an encoding process of a frame; and generating data including a result of the encoding process and a result of the recognition processing; wherein the recognition processing only on a frame of a B picture is performed when a processing cost of a most recent recognition processing is greater than or equal to a predefined amount.

According to the third aspect of the present invention, there is provided a non-transitory computer-readable storage medium storing a computer program for causing a computer to function as: a recognition unit configured to perform a recognition processing of an object on a frame, an encoding unit configured to perform an encoding process of a frame; and a generation unit configured to generate data including a result of the encoding process and a result of the recognition processing; wherein the recognition unit performs the recognition processing only on a frame of a B picture when a processing cost of a most recent recognition processing is greater than or equal to a predefined amount.

Further features of the present invention will become apparent from the following description of exemplary embodiments with reference to the attached drawings.

### BRIEF DESCRIPTION OF THE DRAWINGS

FIG. 1 is a block diagram illustrating a hardware configuration example of a network camera 100;

FIG. 2 is a diagram illustrating a case in which a delay occurs due to an encoding process;

FIG. 3 is a diagram illustrating a case in which the delay further increases when the object recognition processing is added before the encoding process;

FIG. 4 is a flowchart of encoded data generation process performed by the network camera 100;

FIG. 5 is a flowchart illustrating details of the process in step S402;

FIG. 6 is a flowchart illustrating details of the process in step S501; and

FIG. 7 is a diagram describing effects of the first embodiment.

### DESCRIPTION OF THE EMBODIMENTS

Hereafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

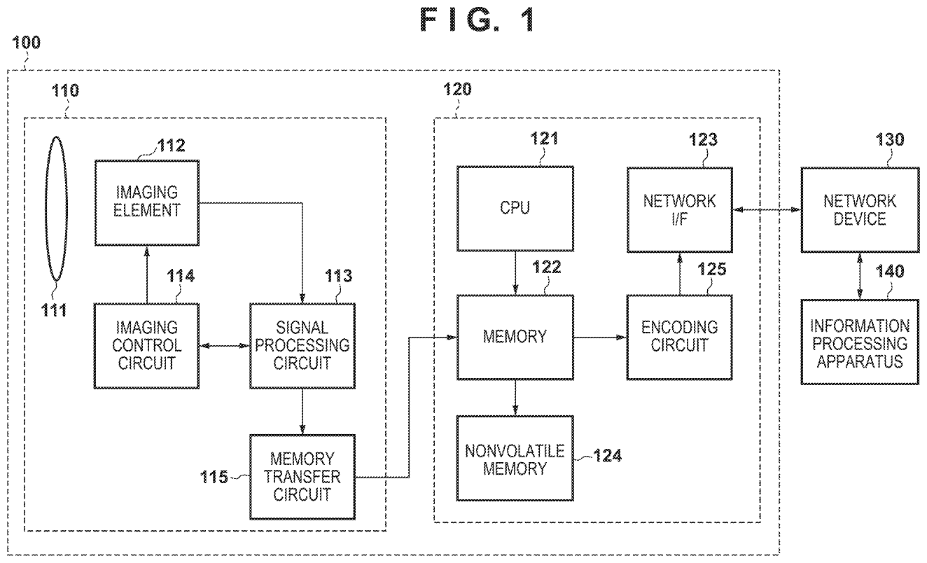

First, a hardware configuration example of a network camera 100 serving as an example of an image processing apparatus according to the present embodiment will be described with reference to a block diagram illustrated in FIG. 1. As illustrated in FIG. 1, the network camera 100 includes an imaging unit 110 and a controller unit 120.

First, the imaging unit 110 will be described. Light entering from the outside via an optical lens 111 forms an image on an imaging element 112. The imaging element 112 is a sensor such as a CCD sensor or a CMOS sensor, and converts light entering through the optical lens 111 into an analog image signal by photoelectric conversion, and outputs the analog image signal to a signal processing circuit 113 in the subsequent stage. The signal processing circuit 113 generates a digital image signal by performing various types of processing including A/D conversion, color conversion processing, noise removal processing, and the like on the analog image signal. Then, the signal processing circuit 113 outputs an image (frame) based on the generated digital image signal to a memory transfer circuit 115 in the subsequent stage. The signal processing circuit 113 may continuously perform such an operation, in which case, frames are continuously output from the signal processing circuit 113. On the other hand, the signal processing circuit 113 may perform such an operation regularly or irregularly, in which case, the frame is output from the signal processing circuit 113 regularly or irregularly.

An imaging control circuit 114 performs an operation control of the imaging element 112 in the same cycle as the output cycle of the image. Furthermore, in a case in which an accumulation time of the image is longer than the output cycle of the image, the imaging control circuit 114 controls the signal processing circuit 113 to hold the frame of the frame memory of the signal processing circuit 113 during a period in which the analog image signal cannot be output from the imaging element 112.

When a frame is output from the signal processing circuit 113, the memory transfer circuit 115 transfers the frame to the memory 122 in the controller unit 120.

Next, the controller unit 120 will be described in detail. A CPU 121 executes various types of processing using a computer program and data stored in a nonvolatile memory 124. As a result, the CPU 121 performs an operation control of the entire network camera 100, and executes or controls various types of processing described as processing performed by the network camera 100.

The memory 122 includes an area for storing a frame transferred from the memory transfer circuit 115, a work area used when the CPU 121 and the encoding circuit 125 execute various types of processing, and the like.

The nonvolatile memory 124 stores setting data of the network camera 100, a computer program and data related to activation of the network camera 100, a computer program and data related to basic operation of the network camera 100, and the like. The nonvolatile memory 124 also stores computer programs and data for causing the CPU 121 to execute or control various types of processing described as processing performed by the network camera 100. The computer programs and data stored in the nonvolatile memory 124 are loaded into the memory 122 as appropriate according to the control by the CPU 121 and to be processed by the CPU 121.

An encoding circuit 125 performs recognition processing (object recognition processing) for recognizing an object included in a frame stored in the memory 122 and collecting information (a type, a position, etc. of the object) related to the object, and encoding process for encoding the frame. Although it is described that the encoding circuit 125 performs both the object recognition processing and the encoding process in the present embodiment, a circuit that performs the object recognition processing and a circuit that encodes a frame may be provided instead of the encoding circuit 125.

The encoding circuit 125 generates encoded data including a result of the object recognition processing (information related to the object) as metadata and including a result of the encoding process as body data. The encoding circuit 125 outputs the generated encoded data to an external network device 130 via a network I/F123. A network IF 123 is an interface configured to perform data communication with a network device 130.

The network device 130 is a device for performing data communication between the network camera 100 and the information processing apparatus 140, and is, for example, a network hub. The network device 130 transmits the encoded data output from the network camera 100 via the network I/F123 to the information processing apparatus 140 via a wired and/or wireless network.

The information processing apparatus 140 is a computer apparatus such as a personal computer (PC), a tablet terminal apparatus, or a smartphone. For example, the information processing apparatus 140 receives encoded data transmitted from the network camera 100 via the network device 130, decodes the received encoded data, and displays frame and metadata obtained by the decoding on a display device such as a monitor. Furthermore, for example, the information processing apparatus 140 can perform various settings on the network camera 100 and acquire data stored in the nonvolatile memory 124 via the network device 130.

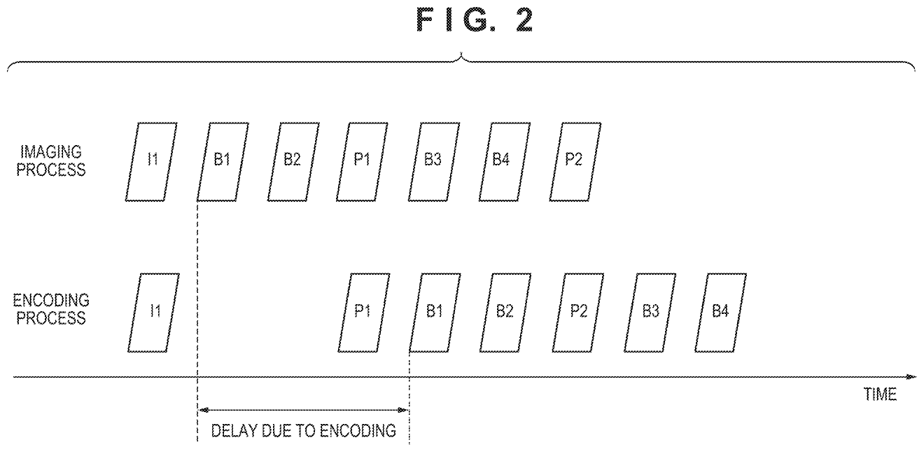

Next, a description will be made of a case in which a delay increases due to relatively advanced object recognition processing and encoding process for each frame. First, a case in which a delay occurs due to the encoding process will be described with reference to FIG. 2. In FIG. 2, it is assumed that the object recognition processing is not performed on the frame in order to clearly describe a case in which a delay occurs due to the encoding process.

I1, B1, B2, P1, B3, B4, and P2 indicate imaged frames are arranged in the order of imaged time-series at the finished time point of the imaging process. That is, the imaging process is finished in the order of I1, B1, B2, P1, B3, B4, and P2. These frames are subjected to the encoding process after the imaging process.

Il is a frame corresponding to an I picture (a frame whose picture type is an I picture) that can be encoded/decoded independently in a GOP. B1, B2, B3, and B4 are frames corresponding to B pictures (frames whose picture type is a B picture) to be encoded/decoded with reference to past frames and future frames. P1 and P2 are frames corresponding to P-pictures (frames whose picture type is a P picture) to be encoded/decoded with reference to past frames. In the example of FIG. 2, the P picture is a picture to be encoded/decoded with reference to a past I picture, and the B picture is a picture to be encoded/decoded with reference to a past I picture and a future P picture.

First, Il is encoded, but as described above, since Il is an I picture and the I picture can be independently encoded, the I picture can be encoded immediately after the imaging process is finished. In the next encoding of B1, both Il and P1 need to be referred to, but as the encoding of B1 cannot be performed until the encoding of both Il and P1 is finished, the encoding of B1 is performed after the encoding of P1 is finished. As described above, in the encoding of the B picture, since the future frame is referred to, a delay due to the encoding is inevitably generated.

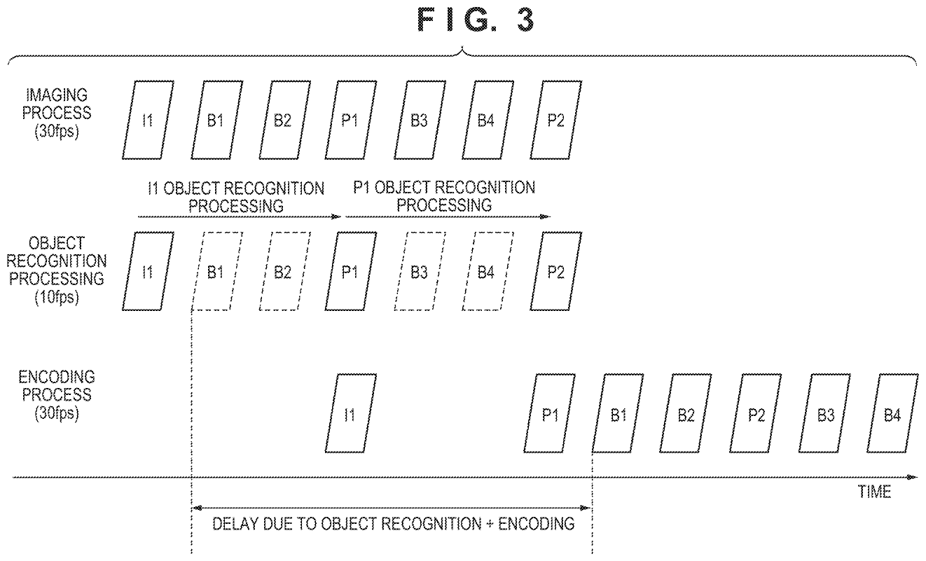

Next, a case where the delay is further increased when the object recognition processing is added before the encoding process in order to add the result of the object recognition processing as metadata to the encoding process will be described with reference to FIG. 3.

In the example of FIG. 3, after the imaging process, the object recognition processing is performed, and then the encoding process is performed. I1, B1, B2, P1, B3, B4, and P2 are similar to in FIG. 2. Furthermore, in FIG. 3, it is assumed that the imaging process and the encoding process are executed at a processing speed of 30 fps, and the object recognition processing is executed at a processing speed of 10 fps. At this time, since the processing speed of the object recognition processing is one third of that of the imaging process, in order to maintain the output of the encoding process at 30 fps, the object recognition processing can be applied only to one out of three frames subjected to the imaging process. Therefore, in the case of FIG. 3, the object recognition processing is applied to I1, P1, and P2. In the object recognition processing in FIG. 3, a frame surrounded by a solid line represents a frame to which the object recognition processing is applied, and a frame surrounded by a dotted line represents a frame to which the object recognition processing is not applied and which proceeds to the encoding process as it is.

First, when the imaging process of Il is finished, the object recognition processing is applied to Il. The imaging process of B1 finishes while the object recognition processing for Il is being executed, but the process proceeds to the encoding process without applying the object recognition processing to B1. However, since the encoding of B1 requires that the encoding of both Il and P1 have been finished, the encoding of B1 cannot be performed at this time point. Therefore, the B1 is in a standby state until the encoding of P1 is finished. It is similar for the subsequent B2. Thereafter, the imaging process of P1 is finished, and the object recognition processing of Il is finished at this time point, and thus the object recognition processing is applied to P1, and then the process proceeds to the encoding process. After the encoding of P1 is completed, B1 and B2 can be encoded.

As described above, when the object recognition processing is executed before the encoding process for a picture group including the B picture, the execution time of the object recognition processing is added as it is in addition to the delay of the encoding process, and there is a possibility that the delay increases.

In the present embodiment, if the number of objects in a frame recognized in the most recent object recognition processing is greater than or equal to a predefined number, the recognition target frame is limited to only the B picture, and the object recognition processing is performed only on the recognition target frame, thereby preventing the increase in the delay.

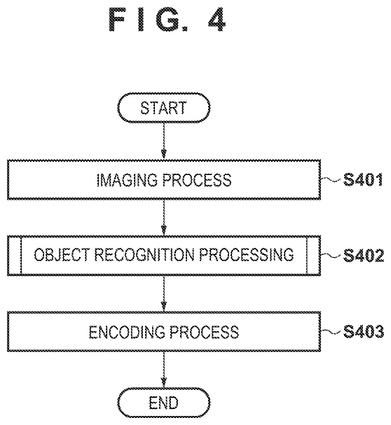

A generation process of encoded data by the network camera 100 according to the present embodiment will be described with reference to the flowchart of FIG. 4.

In step S401, the imaging unit 110 performs imaging process to generate an imaged image for one frame, and transfers the generated imaged image (frame) to the controller unit 120. The transferred frame is stored in the memory 122 of the controller unit 120.

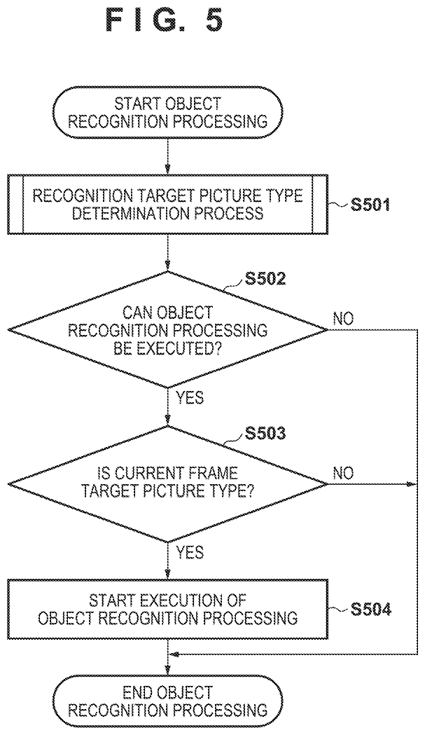

In step S402, the encoding circuit 125 in the controller unit 120 performs object recognition processing on the frame transferred from the imaging unit 110 and stored in the memory 122. The process in step S402 will be described in detail with reference to the flowchart of FIG. 5.

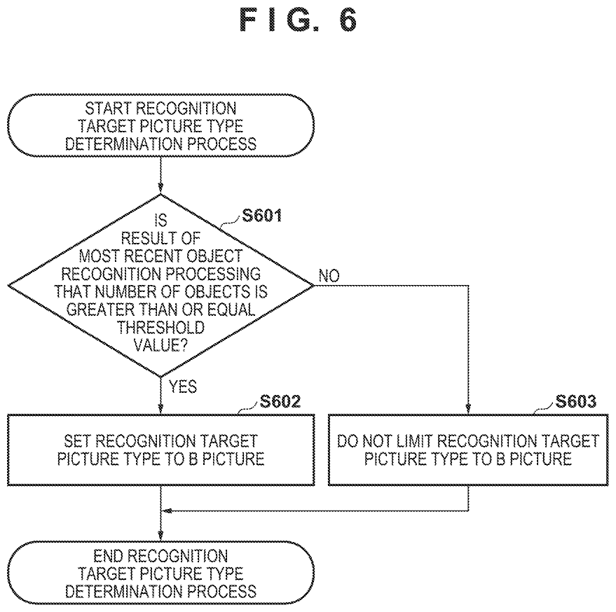

In step S501, the encoding circuit 125 performs a determination process of determining a type of a picture (recognition target picture type) to be subjected to the object recognition processing. The process in step S501 will be described in detail with reference to the flowchart of FIG. 6.

In step S601, the encoding circuit 125 determines whether or not the number of objects recognized from the frame in the most recent object recognition processing is greater than or equal to a threshold value (predefined number). The threshold value is not limited to a value set by a specific setting method, and may be, for example, a predefined value defined in advance or a value set by the user operating the information processing apparatus 140 or the network camera 100.

As a result of this determination, if the number of objects recognized from the frame in the most recent object recognition processing is greater than or equal to the threshold value, the process proceeds to step S602. On the other hand, if the number of objects recognized from the frame in the most recent object recognition processing is less than the threshold value, the process proceeds to step S603.

In step S602, the encoding circuit 125 sets the recognition target picture type to a B picture. That is, the encoding circuit 125 sets a frame corresponding to a B picture as a recognition target frame. In general, in the case of advanced object recognition processing for recognizing the type of an object, as the number of objects in a frame increases, the longer the time the object recognition processing on the frame takes. Therefore, in the present embodiment, in a case where the number of objects recognized from the frame in the most recent object recognition processing is relatively large (in a case where the number is greater than or equal to the threshold value), it is determined that the object recognition processing on the frame to be subjected to the object recognition processing from now takes a relatively long time, and the target of the object recognition processing is limited to the B picture. As a result, since the object recognition processing for the B picture can be executed during the waiting time for waiting the encoding process of the B picture, an increase in delay can be prevented.

In step S603, the encoding circuit 125 determines that it does not take long time to increase the delay even if the object recognition processing is executed on all the pictures (I picture, B picture, P picture), and does not limit the recognition target picture type to the B picture. That is, the encoding circuit 125 sets all the pictures (I picture, B picture, and P picture) as the recognition target picture type. That is, the encoding circuit 125 sets all frames as the recognition target frames regardless of the picture type.

Then, the process proceeds to step S502. In step S502, the encoding circuit 125 determines whether or not the object recognition processing can be executed. For example, the encoding circuit 125 determines that the object recognition processing can be executed when the object recognition processing is not being executed on the frame one frame before. On the other hand, the encoding circuit 125 determines that the object recognition processing is not executable when the object recognition processing is being executed on the frame one frame before.

As a result of this determination, in a case where it is determined that the object recognition processing can be executed, the process proceeds to step S503, and in a case where it is determined that the object recognition processing cannot be executed, the process proceeds to step S403.

In step S503, the encoding circuit 125 determines whether or not a current frame (a frame to be encoded from now) corresponds to a recognition target frame (whether or not the current frame is a frame of a recognition target picture type).

As a result of this determination, in a case where the current frame corresponds to the recognition target frame (the current frame is the frame of the recognition target picture type), the process proceeds to step S504. On the other hand, in a case where the current frame does not correspond to the recognition target frame (the current frame is not the frame of the recognition target picture type), the process proceeds to step S403.

In step S504, the encoding circuit 125 performs the object recognition processing on the current frame. In this object recognition processing, a relatively advanced recognition processing, for example, a process of collecting various information related to the object such as the type of the object included in the frame and the position of the object is performed.

Note that, since the object recognition processing is before the encoding process in the execution order, the picture type of the current frame is not determined at the time point of the object recognition processing. However, it is possible to easily determine which picture type the current frame will be from the order of the picture types in the GOP unit.

In step S403, the encoding circuit 125 performs an encoding process of encoding the frame transferred from the imaging unit 110 and stored in the memory 122. Then, the encoding circuit 125 generates encoded data including the result of the object recognition processing in step S402 as metadata and the result of the encoding process in step S403 as body data.

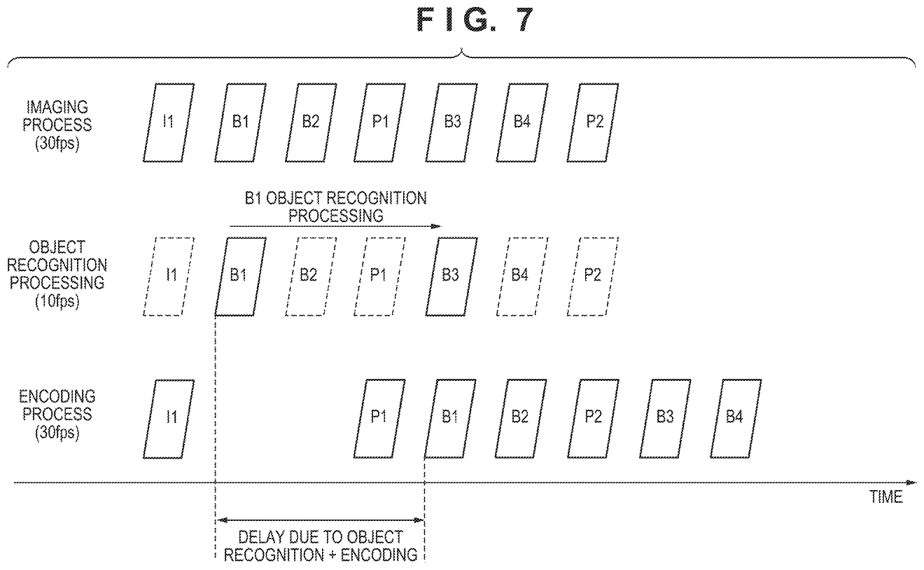

Next, effects of the present embodiment will be described with reference to FIG. 7. Here, it is assumed that a B picture is set as a recognition target frame. At this time, first, when the imaging process of Il is finished, since the picture type of Il is an I picture, it is determined that Il does not correspond to the recognition target frame, and thus, the object recognition processing is not executed on I1, and the encoding process is executed.

Next, when the imaging process of B1 is finished, since the picture type of B1 is a B picture, it is determined that B1 corresponds to the recognition target frame, and thus the object recognition processing is executed on B1.

Thereafter, although the imaging process of B2 is finished, the picture type of B2 is a B picture and corresponds to the recognition target frame, but the object recognition processing for B1 is currently being executed, and thus it is determined that the object recognition processing for B2 cannot be executed. Therefore, the object recognition processing is not executed for B2.

Next, the imaging process of the P1 frame is finished, but since the picture type of P1 is a P picture, it is determined that P1 does not correspond to the recognition target frame, and thus the object recognition processing is not executed on P1, and the encoding process is executed.

Thereafter, the encoding of Il and P1 is finished at the time point the object recognition processing for B1 is finished, and hence the encoding process for B1 can be immediately executed after the object recognition processing is finished. When the encoding of Il and P1 is finished, the encoding of B2 also becomes possible, so that the encoding process can also be executed for B2.

As described above, according to the present embodiment, since the object recognition processing can be executed during the standby time for the encoding process, an increase in delay caused by executing the advanced object recognition processing before the encoding process can be prevented.

### Second Embodiment

In step S601 described above, whether or not the time required for the most recent object recognition processing is longer than or equal to a threshold value (longer than or equal to a predefined time) may be determined. In this case, in a case where the time required for the most recent object recognition processing is longer than or equal to the threshold value, the process proceeds to step S602, and in a case where the time required for the most recent object recognition processing is less than the threshold value, the process proceeds to step S603.

Furthermore, in step S601 described above, whether or not the average time of the time required for the object recognition processing in the most recent predefined number of frames is longer than or equal to a threshold value (longer than or equal to a predefined time) may be determined. In this case, in a case where the average time is longer than or equal to the threshold value, the process proceeds to step S602, and in a case where the average time is less than the threshold value, the process proceeds to step S603.

The predefined time may be a predetermined time, or a time usable for the object recognition processing may be calculated from the frame rate of the imaging process, and the calculated time may be set as the predefined time. For example, in a case where the imaging process is a frame rate of 30 fps, the processing time per frame is less than or equal to 33 milliseconds, and the time required for the encoding process and other process is subtracted therefrom to calculate the time usable for the object recognition processing.

In this manner, whether or not the processing cost of the most recent recognition processing is greater than or equal to the predefined amount is determined, and when the processing cost of the most recent recognition processing is greater than or equal to the predefined amount, various modes can be considered as modes in which the object recognition processing is performed only on the frame of the B picture, and the mode is not limited to a specific mode.

Furthermore, when the set frame rate exceeds a predetermined reference frame rate, only the B picture may be set as the recognition target frame, or whether or not only the B picture is set as the recognition target frame may be determined according to a user operation.

In addition, although FIG. 1 illustrates the network camera 100 in which the imaging unit 110 and the controller unit 120 are integrated, the imaging unit 110 and the controller unit 120 may be separate devices. Furthermore, the controller unit 120 may be incorporated in the information processing apparatus 140.

Moreover, the transmission destination of the encoded data is not limited to the information processing apparatus 140. For example, the network camera 100 may transmit the generated encoded data to a device on a network such as a server device and store the encoded data in the server device, or may transmit the encoded data as broadcast data to a television device.

Alternatively, the numerical values, processing timings, processing orders, processing entities, and data (information) acquiring method/transmission destination/transmission source/storage location, and the like used in the embodiments described above are referred to by way of an example for specific description, and are not intended to be limited to these examples.

Alternatively, some or all of the embodiments described above may be used in combination as appropriate. Alternatively, some or all of the embodiments described above may be selectively used.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An image processing apparatus comprising:
a recognition unit configured to perform a recognition processing of an object on a frame;
an encoding unit configured to perform an encoding process of a frame; and
a generation unit configured to generate data including a result of the encoding process and a result of the recognition processing,
wherein the recognition unit performs the recognition processing only on a frame of a B picture when a processing cost of a most recent recognition processing is greater than or equal to a predefined amount.

2. The image processing apparatus according to claim 1, wherein the recognition unit performs the recognition processing only on a frame of a B picture if the number of objects in the frame recognized in the most recent recognition processing is greater than or equal to a predefined number.

3. The image processing apparatus according to claim 1, wherein the recognition unit performs the recognition processing only on a frame of a B picture when a time required for most recent recognition processing is longer than or equal to a predefined time.

4. The image processing apparatus according to claim 1, wherein the recognition unit performs the recognition processing only on a frame of a B picture when an average time of a time required for the recognition processing of a most recent predefined number of frames is longer than or equal to a predefined time.

5. The image processing apparatus according to claim 1, further comprising an output unit configured to output the data generated by the generation unit.

6. The image processing apparatus according to claim 1, further comprising an imaging unit,
wherein the recognition unit performs the recognition processing on a frame imaged by the imaging unit, and
the encoding unit performs the encoding process of a frame imaged by the imaging unit.

7. The image processing apparatus according to claim 6, wherein the image processing apparatus is a network camera.

8. An image processing method performed by an image processing apparatus, the method comprising:
performing a recognition processing of an object on a frame;
performing an encoding process of a frame; and
generating data including a result of the encoding process and a result of the recognition processing,
wherein the recognition processing only on a frame of a B picture is performed when a processing cost of a most recent recognition processing is greater than or equal to a predefined amount.

9. A non-transitory computer-readable storage medium storing a computer program for causing a computer to function as:
a recognition unit configured to perform a recognition processing of an object on a frame;
an encoding unit configured to perform an encoding process of a frame; and
a generation unit configured to generate data including a result of the encoding process and a result of the recognition processing,
wherein the recognition unit performs the recognition processing only on a frame of a B picture when a processing cost of a most recent recognition processing is greater than or equal to a predefined amount.
